(19) United States
(12) Patent Application Publication
(10) Pub. No.: US 2007/0251367 A1
(43) Pub. Date: Nov. 1, 2007

(54) Paper guide for hole punch

(76) Inventors: Benjamin Hermance, Worcester, MA (US); William Chura, Medford, MA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/487,938

(22) Filed: Jul. 17, 2006

Related U.S. Application Data
(60) Provisional application No. 60/761,503, filed on Jan. 23, 2006.

(51) Int. Cl. B26D 5/08

(52) U.S. Cl. 83/627; 83/467.1; 83/684

(57) ABSTRACT

A desktop hole punch device for punching holes in stacked sheet media such as paper is disclosed. The hole punch device includes at least one adjustable, laterally extending arm having markings thereon indicating standard office paper sizes. The markings are visible to the user through a window in the device. An edge guide at the distal end of the arm aligns the stack of sheet media and a curved page lifter extending from the edge guide reverses the natural curl in the paper stack for better and more precise hole punching.

This application claims priority from U.S. Provisional Application No. 60/761,503, filed on Jan. 23, 2006, the contents of which are hereby incorporated by reference in their entirety.

### BACKGROUND OF THE INVENTION

Generally, the present invention is directed to a paper guide for a manually operated hole punch used to punch one or more holes in sheet media such as paper. Examples of such manually operated hole punches include U.S. Pat. No. 3,921,487 (Otsuka, et al.), U.S. Pat. No. 4,077,288 (Holland), and U.S. Pat. No. 6,688,199 (Godston, et al.). In such hole punch devices, a punch pin that cuts through the paper stack is slidably held in a rigid frame, which receives the paper stack. The assembly of the punch pin and the rigid frame is known as the punch element. The punch pin is driven through the paper stack to cut a through-hole. The paper stack fits in a slot that serves as the holding area for the punching operation. The slot is usually oriented so that it opens horizontally. With the paper stack residing in the slot, the punch pin with its sharp leading edge cuts through the stack and expels the cut, disk-shaped chips on the opposite side of the stack.

The energy to drive the pin in its punching stroke originates from an actuation lever that is linked to the punch pin to advance it through the slot and paper stack. The lever is linked to a handle or it may be directly actuated by the user applying force to it or the handle. An optional return spring engaging the punch pin, lever, or handle is biased so that it assists in the withdrawal stroke of the punch pin out of the punched hole.

In order for the hole in the paper stack to be punched neatly and in alignment with one another, the loose stack of papers must itself be neatly aligned before being punched. This is sometimes more of an issue for a hole punch that has a slot opening upwards where the papers nearly stand on edge. The stack of papers thus oriented tends to have a natural bow or curl across its entire length or width when sitting inside the slot, which bow or curl can cause misalignment when the hole or holes are punched.

### SUMMARY OF THE INVENTION

The present invention in a preferred embodiment is directed to a punch device for cutting holes in stacked sheet media. The punch has a frame having a generally vertically-oriented slot for receiving the sheet media therein, a punch element extending a punch pin perpendicularly through the slot, a handle driving the punch element, at least one extension arm having a distal end extending laterally from the frame and a proximal end remaining inside the frame, wherein the extension arm includes markings thereon, an edge guide having a smooth inner face disposed at the distal end of the extension arm, wherein the edge guide includes an inward extending page lifter, and an opening in the frame forming a window such that the markings on the extension arm are visible through the window. The window is situated above the slot so that it is not covered by the paper stack loaded into the slot and is constantly visible to the user.

The punch device in the preferred embodiment includes an extension arm on each side of the frame extending laterally therefrom, and each extension arm includes an edge guide at a distal end thereof. The edge guide preferably has a longitudinal shape and is tilted in parallel with the slot. In addition, the punch device has a window that is optionally covered by a transparent material, and the page lifter includes a curved planar shape. The page lifter may further define a plane that is not co-planar with a plane defined by the slot.

Internally, the punch device is designed so that the two extension arms are ratcheted to each other via a common pinion gear disposed to the interior of the frame.

With these features, the punch device improves the hole punching operation in sheet media by quickly enabling the correct page size to be selected by using the window and marked indicia, overcoming any natural curl in the sheet media to ensure precise and clean hole cuts, and quickly aligning the stack and sheet media by employing one or more guides.

### BRIEF DESCRIPTION OF THE DRAWINGS

FIG. 1(a) is a side elevational view of a preferred embodiment hole punch with a single edge guide.

FIG. 1(b) is a front elevational view of the hole punch from FIG. 1.

FIG. 1(c) is a cross-sectional view of the hole punch taken along line B-B of FIG. 1(b).

FIG. 1(d) is a cut-away perspective view of the hole punch where one side has been removed to expose the interior.

FIG. 2 is a perspective view of another hole punch embodiment with two edge guides retracted or closed.

FIG. 3 is a perspective view of the hole punch showing the edge guides extended or open.

FIG. 4 is a top plan view.

FIG. 5 is back perspective view.

### DETAILED DESCRIPTION OF THE PREFERRED EMBODIMENTS

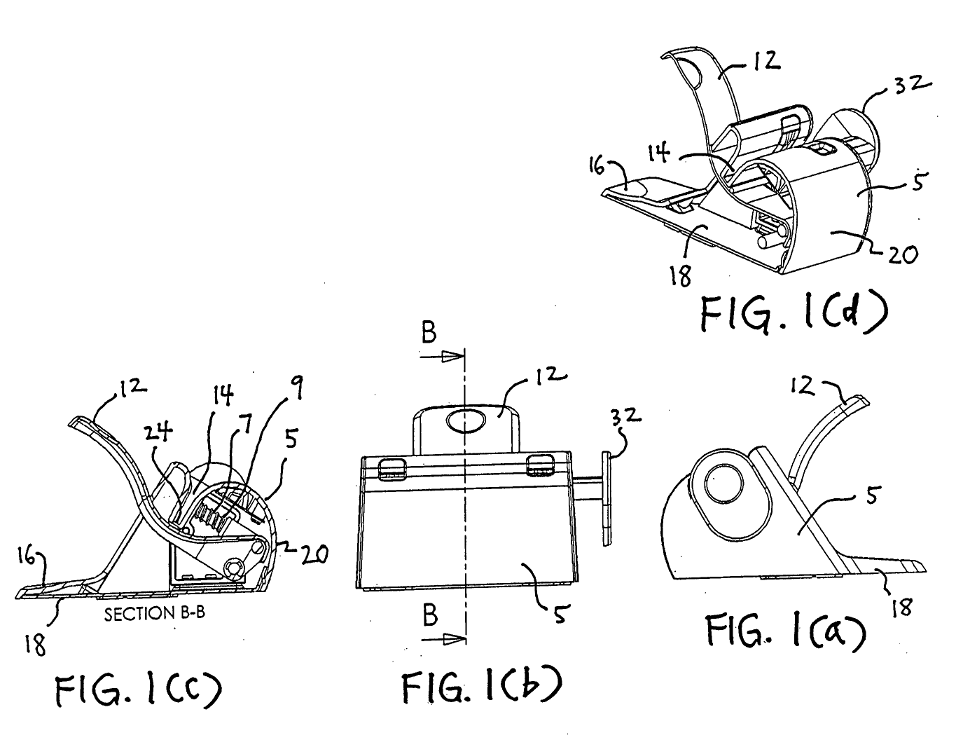

The present invention is directed to a paper guide for a hole punch, shown in FIGS. 1-5. FIG. 1(a) is a side elevational view of a preferred embodiment hole punch 5. The hole punch 5 is further shown in a front elevational view in FIG. 1(b), in a cross-sectional view in FIG. 1(c), and in a cut away view in FIG. 1(d). This embodiment includes a housing body 20 covering the internal punch element mechanicals, one edge guide 32 for helping arrange the paper stack to be punched, and a nearly-vertically oriented slot 14 for receiving the paper stack.

The preferred embodiment hole punch includes one or more punch elements with respective punch pins 7. As seen in the cross-sectional view of FIG. 1(c), an actuation handle or lever 12 is linked to the punch pin 7 to drive it through a stack of papers or like sheet media (not shown) residing in the slot 14. A reset spring 9 assists in the withdrawal of the punch pin 7 after the punch stroke to return the mechanicals to the start position. The structure and operation of the punch element, actuation handle, etc., are disclosed in, for example, U.S. application Ser. No. 11/336,300, titled “HOLE PUNCH” by Joel S. Marks, filed Jan. 20, 2006, whose entire contents are incorporated by reference.

To receive the papers, the hole punches 5, 10 depicted in FIGS. 1 and 3-5 have a slot 14 which in the preferred embodiment opens upward but at an angle slightly off the vertical. The lever 12 includes a grooved or indented pressing area 16 for improved grip of the user to better apply a driving force. The hole punch superstructure and internal mechanisms sit generally atop a stable platform or base 18.

As best seen in FIGS. 1(c) and 3, the manually operated hole punches 5, 10 have a housing body 20 with a near-vertical slot 14 for accepting the sheet media or paper stack therein. The slot 14 includes an opening 22 leading to the closed bottom 24 of the slot 14. The almost vertical orientation of the slot 14 ensures that when the paper stack is inserted therein it remains situated almost vertically. This slot orientation minimizes table top surface area generally occupied and shrinks the footprint for the hole punches 5, 10. In addition, the almost vertical orientation of the slot 14 exploits the pull of gravity on the paper stack to make sure the leading edge is fully inserted into the slot, and to work in concert with the edge guide described in further detail below.

First and second guide surfaces 26, 28 adjacent the slot opening 22 help the paper or sheet media feed into the slot 14. Preferably, the guide surfaces 26, 28 are a curved surfaces arranged in a confluence such that the gap therebetween narrows down to the gap defined by the slot height.

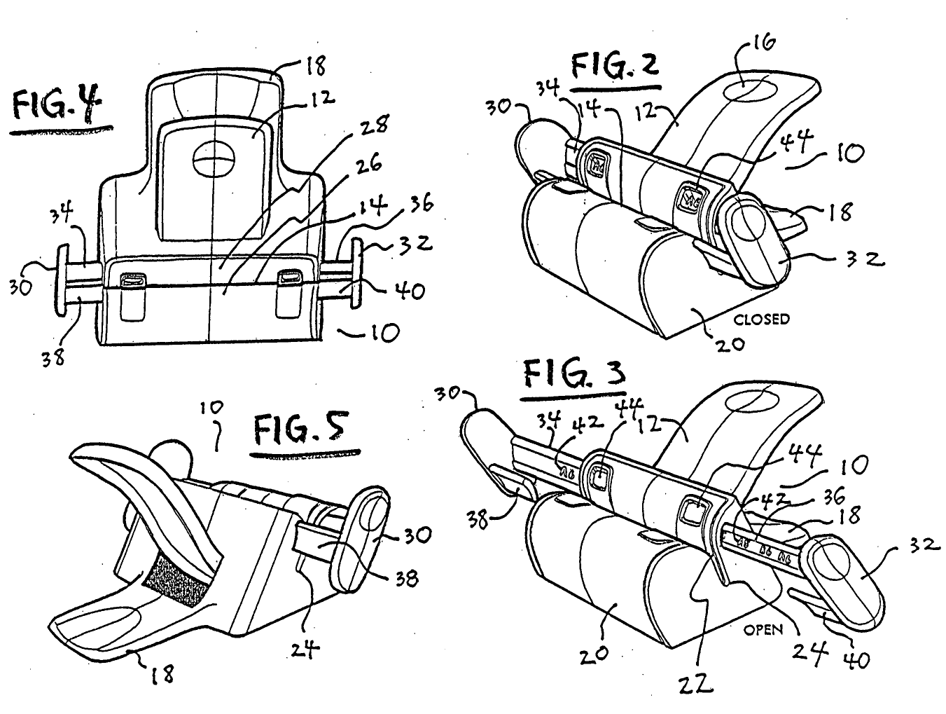

In the embodiment of FIGS. 2-5, on opposite sides of the width of the slot 14 are paper or sheet media edge guides 30, 32. There can be one edge guide or more than the two that are shown. Each paper edge guide 32 has a large flat surface that faces the edge of the paper stack and is generally oriented in a direction parallel to the slot 14. So as seen in FIGS. 2-3, the edge guides 30, 32 are oriented slightly off the vertical as is the slot 14.

At least one edge guide 30, 32 projects from the side of the housing body 20 via an extension arm 34, 36. The extension arm 34, 36 slides into and out of the body 20 to adjust the distance between the opposing edge guides 30, 32. This in turn accommodates the hole punch 10 to accept different sized papers such as standard letter 8.5″×11″, A4, or 8.5″×14″ legal size, etc., or different orientation of papers. Regarding the latter orientation, an 8.5″×11″ paper can thus be placed inside the slot 14 with the narrow 8.5-inch side inside the slot or the 11-inch side inside the slot, and the edge guides 30, 32 can be slidably adjusted to match those sizes.

In one alternative embodiment, the two extension arms are ratcheted to a toothed, rotating pinion inside the housing (not shown) so the two extension arms can slide simultaneously in opposite directions. The edge guides 30, 32 once adjusted to the correct stack width help align the loose papers in the stack.

Each edge guide 30, 32 further includes optional lifter tabs 38, 40 that have a slight curvature. The lifter tabs 38, 40 counteracts gravity and the natural bowing in the paper or sheet media stack by gently lifting the unsupported outer edges of the paper stack. That is, the flat part of the paper stack at the outer periphery is supported by the lifter tabs 38, 40. Moreover, the optional slight curvature of the lifter tabs 38, 40 places a slight reverse bend to the bowed papers. To visualize this, in the top plan view of FIG. 4, the paper stack would normally bow to form a convex curve (i.e., a frown) across the slot 14, while lifter tabs 38, 40 would diminish the convexity of the sheet stack and induce a concave bend (i.e., a smile) across the width of the slot 14. The ideal end result is a sheet stack that rests straight across the width of the slot 14 for improved alignment prior to the hole punching step.

Each extension arm 34, 36 optionally includes markings or indicia 42 that provide the numeric dimensions of the paper or sheet media (e.g., 8.5″, 11″, 14″, 210 mm, 297 mm, etc.) or alphabetic designations of the paper size (e.g., LTR, LGL, A4, etc.). The indicia 42 may be a sticker, inked, etched, cut, stamped, embossed into the arm, a raised contour on the arm, or the like. The arm 34, 36 may be metal, plastic, or the like so creation of the indica 42 on the arm 34, 36 is achieved through processes known in the art.

So that the user can see the indicia 42 in order to make the proper in/out adjustment of the edge guides 30, 32, a window 44 is provided in the guide surface 26. The window 44 may be covered by a transparent sheet of plastic to keep dust or paper chips from accidentally falling into the window and collecting inside.

In the preferred embodiment, the hole punch 10 includes multiple punch pins/punch elements, and the spacings between them are fixed. In an alternative embodiment, the distance between the punch pins may be adjustable by the user. Therefore, the holes to be cut may be set at pre-marked spacings. To allow the user to move the punch elements to the correct spacings, the punch elements slide on a bar (not shown) with the indicia described above and are screwed down or locked down to the bar at preset detents or notches. The indicia on the bar to adjust the punch element spacings may be likewise made visible through the window.

Moreover, in another alternative embodiment, the punch elements are linked to the edge guides so moving the edge guides moves the respective punch elements. Thus, the indicia seen through the windows informs the user of the hole spacing as well as the paper size.

Notably, the windows 44 are located above the slot 14 so that they are visible to the user even though the slot 14 is occupied by a stack of papers. The slight angle of the slot 14 and the weight of the paper stack curl the stack forward toward the user and downward toward the desktop, and away from covering the windows 44. Since the windows 44 and indica 42 inside are constantly visible to the user, he or she can rest assured that the paper stack is reliably and repeatedly aligned with the punch elements and that the edge guide has not inadvertently slipped out of alignment or out of its detent for a selected paper size.

From the foregoing detailed description, it should be evident that there are a number of changes, adaptations and modifications of the present invention that come within the province of those skilled in the art. However, it is intended that all such variations not departing from the spirit of the invention be considered as within the scope thereof as limited solely by the following claims.

We claim:

1. A punch device for cutting holes in sheet media, comprising:
a frame having a near vertically opening slot for receiving the sheet media;
a punch element extending a punch pin perpendicularly through the slot;
a handle driving the punch element;
at least one extension arm having a distal end extending laterally from the frame and a proximal end remaining inside the frame, wherein the extension arm includes markings thereon;
an edge guide having a smooth inner face disposed at the distal end of the extension arm; and
an opening in the frame forming a window above the slot such that the markings on the extension arm are visible through the window and not covered by the sheet media received in the slot.

2. The punch device of claim 1, wherein the punch device includes an extension arm on each side of the frame extending laterally therefrom, and each extension arm includes an edge guide at a distal end thereof.

3. The punch device of claim 1, wherein the window is covered by a transparent material.

4. The punch device of claim 1, wherein the edge guide includes a page lifter extending perpendicular therefrom and having a curved shape.

5. The punch device of claim 2, wherein the two extension arms are ratcheted to each other via a common pinion gear disposed to the interior of the frame.

6. The punch device of claim 1, wherein the slot opens upward and is oriented generally perpendicular to a desktop surface on which the punch device rests.

7. The punch device of claim 1, wherein the page lifter defines a plane that is not co-planar with a plane defined by the slot.

8. The punch device of claim 1, wherein the edge guide has a longitudinal shape and is tilted in parallel with the slot.

9. The punch device of claim 1, wherein the window and the handle are on opposite sides of the frame and the window is faces away from the handle.

10. A punch device for cutting holes in a stack of sheet media, comprising:
a frame having a substantially vertically opening slot for receiving the stack of sheet media therein;
a punch element extending a punch pin perpendicularly through the slot;
a handle linked to the punch element;
two opposed extension arms each having a distal end extending laterally from the frame and a proximal end remaining inside the frame, wherein the extension arms include markings thereon;
an elongated edge guide having a smooth inner face disposed at the distal end of each extension arm, wherein the edge guide includes an inward extending page lifter; and
two openings in the frame forming respective windows above the slot such that the markings on each extension arm are visible through the respective window and are not covered by the stack of sheet media.

11. The punch device of claim 10, wherein the page lifter is located beneath the extension arm and slightly non-coplanar with a plane defined by the slot and the page lifter further includes a polygonal shape with a curved surface to engage the outer edge of the stack of sheet media.

12. The punch device of claim 10, wherein the windows are covered in a transparent plastic.

13. The punch device of claim 10, wherein the extension arm, edge guide, and page lifter partially circumscribes the outer edge of the stack of sheet media.

14. The punch device of claim 10, wherein the windows have a curvature.

15. A punch device for cutting holes in sheet media, comprising:
a frame having a near vertically oriented slot for receiving the sheet media;
a means for forming a hole disposed adjacent the slot;
a handle driving the means for forming a hole;
at least one extension arm having a distal end extending laterally from the frame and a proximal end remaining inside the frame, wherein the extension arm includes markings thereon;
an edge guide having a smooth inner face disposed at the distal end of the extension arm, wherein the edge guide includes an inward extending page lifter; and
an opening in the frame forming a window above the slot such that the markings on the extension arm are visible through the window.

16. The punch device of claim 15, wherein the window includes a transparent lens material to magnify the markings on the extension arm.
